(19) United States
(12) Patent Application Publication
(10) Pub. No.: US 2026/0091746 A1
(43) Pub. Date: Apr. 2, 2026

(54) Cargo Area Mounting Brackets in Vehicles

(71) Applicant: Nissan North America, Inc., Franklin, TN (US)

(72) Inventors: Kayla Schmidt, West Bloomfield, MI (US); Brian Haupt, Farmington Hills, MI (US); Praveen Mangalagiri, Southfield, MI (US)

(21) Appl. No.: 18/901,888

(22) Filed: Sep. 30, 2024

(51) Int. Cl. B60R 16/04; H01M 50/244; H01M 50/249

(52) U.S. Cl. CPC B60R 16/04; H01M 50/244; H01M 50/249; H01M 2220/20

(57) ABSTRACT

A vehicle including: a chassis defining a passenger seating area and a cargo area; a trim panel separating the passenger seating area from the cargo area; first, second, and third mounting brackets; and a battery assembly supported by the cross-member and including a battery and a battery case receiving the battery. The chassis includes a floor panel and a cross-member extending upwardly therefrom. The first and third mounting brackets are connected to the floor panel forwardly of the cross-member, and the second mounting bracket is connected to the floor panel rearwardly of the cross-member, wherein the first and second mounting brackets are connected to the battery case to thereby secure the battery assembly within the cargo area, and the first and third mounting brackets are connected to the trim panel to increase the stability thereof.

### TECHNICAL FIELD

The present application relates to mounting brackets that are configured to secure a battery in the cargo area of a vehicle and stabilize a trim panel separating the cargo area from the passenger seating area.

### BACKGROUND

Many modern vehicles include a secondary battery (or other such power source) that is electrically connected to a variety of systems, components, etc. Often times, these secondary batteries are stored in the passenger seating area, which not only occupies valuable space but places restrictions on the availability and style of seating.

The present disclosure addresses this concern by providing mounting brackets that not only secure the secondary battery in the cargo area but stabilize the trim panel separating the cargo area from the passenger seating area.

### SUMMARY

In one aspect of the present disclosure, a vehicle is disclosed that includes: a chassis, which defines a passenger seating area and a cargo area that is located rearwardly of the passenger seating area; a trim panel, which separates the passenger seating area from the cargo area; a first mounting bracket; a second mounting bracket; a third mounting bracket; and a battery assembly.

The chassis includes a floor panel and a cross-member that extends upwardly from the floor panel.

The battery assembly is supported by the cross-member and includes a battery and a battery case that receives the battery.

The first mounting bracket is connected to the floor panel forwardly of the cross-member, the second mounting bracket is connected to the floor panel rearwardly of the cross-member, and the third mounting bracket is connected to the floor panel forwardly of the cross-member. The first mounting bracket and the third mounting bracket are connected to the trim panel to increase the stability thereof, and the first mounting bracket and the second mounting bracket are connected to the battery case to thereby secure the battery assembly within the cargo area.

In certain embodiments, the battery case may be indirectly connected to the first mounting bracket.

In certain embodiments, the battery assembly may further include battery brackets that extend between and connect the battery case and the first mounting bracket.

In certain embodiments, the battery case may be directly connected to the second mounting bracket.

In certain embodiments, the battery case may be directly connected to the cross-member.

In another aspect of the present disclosure, a vehicle is disclosed that includes: a chassis, which defines a passenger seating area and a cargo area that is located rearwardly of the passenger seating area; a battery assembly; a first mounting bracket; and a second mounting bracket.

The chassis includes a floor panel and a cross-member that extends upwardly from the floor panel.

The battery assembly is supported by the cross-member.

The first mounting bracket is connected to the floor panel forwardly of the cross-member, and the second mounting bracket is connected to the floor panel rearwardly of the cross-member, wherein the first mounting bracket and the second mounting bracket are connected to the battery assembly to thereby secure the battery assembly within the cargo area.

In certain embodiments, the first mounting bracket may include: a first foot that is positioned at a first end of the first mounting bracket; a second foot that is positioned at a second end of the first mounting bracket; and a third foot that is positioned between the first foot and the second foot, wherein the first foot, the second foot, and the third foot are directly connected to the floor panel.

In certain embodiments, the first foot, the second foot, and the third foot may extend at an acute angle in relation to a reference axis extending in parallel relation to the length of the vehicle.

In certain embodiments, the first mounting bracket may further include a first support and a second support.

In certain embodiments, the first support may be spaced vertically from the first foot and the third foot and positioned therebetween, and the second support may be spaced vertically from the second foot and the third foot and positioned therebetween such that the first mounting bracket is generally M-shaped in configuration.

In certain embodiments, the battery assembly may be indirectly connected to the first mounting bracket.

In certain embodiments, the battery assembly may include: a battery; a battery case that receives the battery; and battery brackets that extend between and connect the battery assembly and the first mounting bracket.

In certain embodiments, the battery brackets may be connected to the first support and the second support.

In certain embodiments, the vehicle may further include a trim panel that separates the passenger seating area from the cargo area.

In certain embodiments, the trim panel may be connected to the first mounting bracket to increase the stability thereof.

In certain embodiments, the first mounting bracket may further include a first flange that extends downwardly from the first support and a second flange that extends downwardly from the second support, wherein the first flange and the second flange receive first fasteners that connect the trim panel to the first mounting bracket.

In certain embodiments, the vehicle may further include a third mounting bracket that is connected to the floor panel forwardly of the cross-member.

In certain embodiments, the third mounting bracket may receive at least one second fastener that connects the trim panel to the third mounting bracket to increase the stability thereof.

In another aspect of the present disclosure, a vehicle is disclosed that includes: a chassis, which defines a passenger seating area and a cargo area that is located rearwardly of the passenger seating area; a trim panel, which separates the passenger seating area from the cargo area; a battery assembly; and a first mounting bracket and a second mounting bracket.

The chassis includes: a floor panel and a cross-member that extends upwardly from the floor panel.

The battery assembly is supported by the cross-member.

The first mounting bracket and the second mounting bracket are connected to the floor panel, wherein the battery assembly is connected to the first mounting bracket to thereby secure the battery assembly within the cargo area, and the trim panel is connected to the first mounting bracket and the second mounting bracket to increase the stability of the trim panel.

In certain embodiments, the first mounting bracket and the second mounting bracket may be non-identical in configuration.

In certain embodiments, the first mounting bracket and the second mounting bracket may be positioned forwardly of the cross-member.

In certain embodiments, the first mounting bracket and the second mounting bracket may be generally aligned along the width of the vehicle.

In certain embodiments, the vehicle may further include: a storage box that is positioned within the cargo area; a platform that extends between the storage box and the trim panel; and carpeting that is positioned within the cargo area, wherein the carpeting extends beneath the first mounting bracket.

### BRIEF DESCRIPTION OF THE DRAWINGS

According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIG. 1 is a partial, top, plan view of a vehicle that includes: a chassis; a trim panel; a battery assembly; a first mounting bracket; a second mounting bracket; and a third mounting bracket according to the principles of the present disclosure.

FIG. 2 is a partial, longitudinal, cross-sectional view of the vehicle illustrating: the battery assembly; the first mounting bracket; and the second mounting bracket.

FIG. 3 is a top, plan view illustrating: the battery assembly; the first mounting bracket; and the second mounting bracket.

FIG. 4 is a front, perspective view of the battery assembly and the first mounting bracket.

FIG. 5 is a rear, perspective view of the battery assembly and the second mounting bracket.

FIG. 6 is a cross-sectional view taken along line 6-6 in FIG. 3 and shown in perspective.

FIG. 7 is a partial, rear, perspective view of the third mounting bracket.

### DETAILED DESCRIPTION

The present disclosure describes a variety of mounting brackets for use in securing a battery assembly atop a cross-member within the cargo area of a vehicle and stabilizing a trim panel, which separates the cargo area from a passenger seating area.

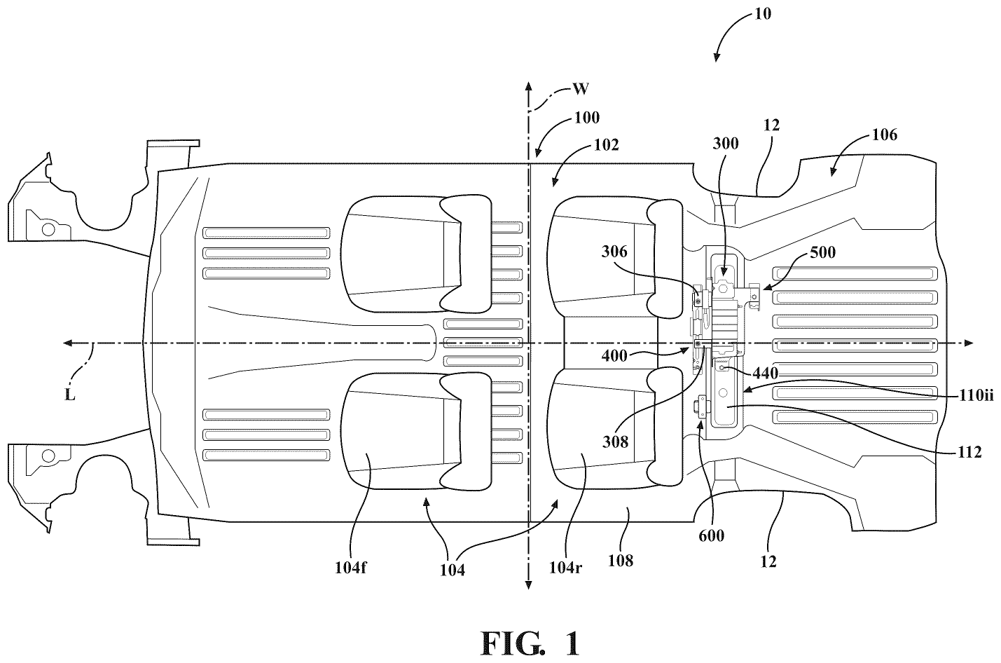

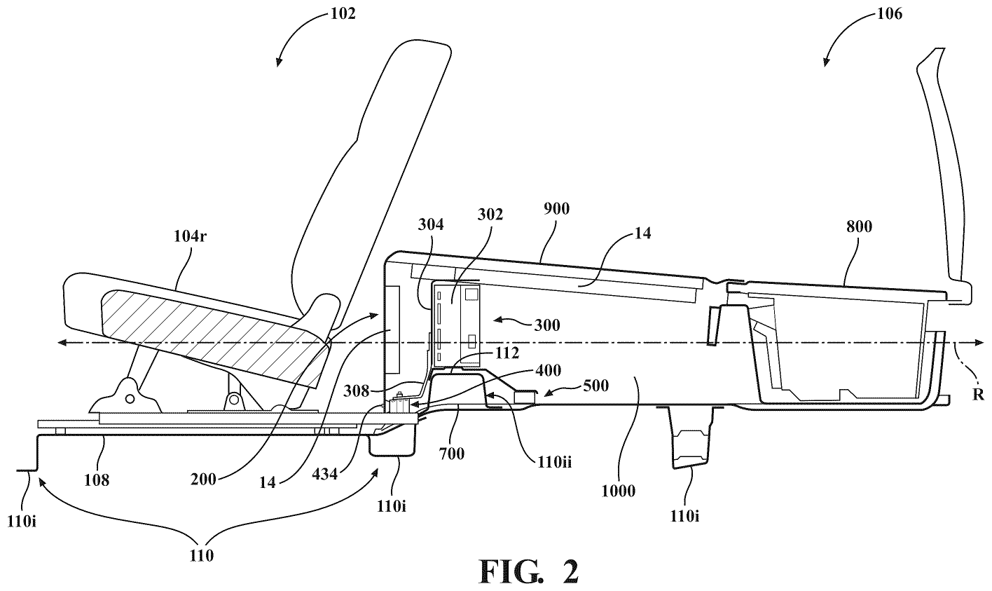

With reference to FIGS. 1 and 2, a vehicle 10 is disclosed that includes: a chassis 100; a trim panel 200; a battery assembly 300; a (first) mounting bracket 400; a (second) mounting bracket 500; and a (third) mounting bracket 600. Although generally illustrated and described in the context of a passenger vehicle, it should be appreciated that the principles of the present disclosure may be applied to a wide variety of vehicles (e.g., trucks, SUVs, vans, buses, boats, airplanes, trains, etc.).

The chassis 100 defines a passenger seating area 102, which accommodates a plurality of seats 104 (e.g., forward seats 104f and rear seats 104r), and a cargo area 106, which is positioned (located) rearwardly of (behind) the passenger seating area 102 along the length L of the vehicle 10. As seen in FIG. 2, within the cargo area 106, the vehicle 10 further includes: carpeting 700; a storage (luggage) box 800; and a platform 900 that extends between the trim panel 200 and the storage box 800 so as to define an internal compartment 1000, which is positioned (located) between the storage box 800 and the seats 104 (i.e., the rear seats 104r) and receives (accommodates) the battery assembly 300 (amongst other components), as described in further detail below.

The chassis 100 includes a floor panel 108 and a plurality of cross-members (braces) 110, which are connected (secured) to the floor panel 108 and extend laterally across the width W of the vehicle 10 (i.e., in generally orthogonal (perpendicular) relation to the length L of the vehicle 10) to increase the strength (e.g., the rigidity) of the floor panel 108. More specifically, the chassis 100 includes (first) cross-members 110i, which extend downwardly from the floor panel 108, and (one or more) at least one (second) cross-member 110ii, which extends upwardly from the floor panel 108 into the cargo area 106 and establishes a continuous load path that extends around wheel wells 12 (FIG. 1) of the vehicle 10. As seen in FIG. 2, the cross-member 110ii is positioned (located) within the internal compartment 1000 (i.e., rearwardly of (behind) the passenger seating area 102) and defines an (exposed) top surface 112.

The trim panel 200 separates the passenger seating area 102 from the cargo area 106 and is positioned (located) rearwardly of (behind) the seats 104 (i.e., the rear seats 104r). The trim panel 200 extends vertically between the carpeting 700 and the platform 900 and is connected to the mounting brackets 400, 600, as described in further detail below, which increases the stability of the trim panel 200 so as to inhibit (if not entirely prevent) unintended movement thereof. As seen in FIG. 2, the trim panel 200, the storage box 800, the platform 900, and the floor panel 108 collectively define and enclose the internal compartment 1000, which reduces road noise within the vehicle 10. In order to further reduce road noise within the vehicle, in certain embodiments, such as that illustrated in FIG. 2, it is envisioned that the vehicle 10 may further include (one or more) at least one insulator 14, which may be connected (secured) to the trim panel 200, the platform 900, and/or any other suitable component of the vehicle 10.

In the illustrated embodiment, the trim panel 200 extends in generally orthogonal (perpendicular) relation to a reference axis R, which extends in parallel relation to the length L of the vehicle 10. Embodiments in which the trim panel 200 may extend at an acute angle in relation to the length L of the vehicle 10 are also envisioned herein (e.g., depending upon the particular configuration of the passenger seating area 102 and/or the cargo area 106), however, and would not be beyond the scope of the present disclosure.

The battery assembly 300 includes: a battery 302; a battery case 304, which houses (receives, accommodates) the battery 302 and supports other components of the vehicle 10 (e.g., wiring harnesses, electrical components, tubing, etc.); and (first and second) battery brackets 306, 308, which are connected to and extend from the battery case 304.

In the illustrated embodiment, the battery case 304 and the battery brackets 306, 308 are configured as discrete components of the battery assembly 300. Embodiments in which the battery case 304 and (one or more) at least one of the battery brackets 306, 308 may be integrally (unitarily, monolithically) formed from a single piece of material are also envisioned herein, however, and would not be beyond the scope of the present disclosure.

As indicated above, the battery assembly 300 is positioned (located) within the internal compartment 1000. More specifically, the battery assembly 300 is directly supported by and is positioned (located) atop the cross-member 110ii (i.e., the top surface 112). As seen in FIG. 1, the battery assembly 300 is generally centered along the width W of the vehicle 10, which protects the battery assembly 300 in the event of an impact. Supporting the battery assembly 300 atop the cross-member 110ii removes the battery assembly 300 from the passenger seating area 102 but positions (locates) the battery assembly 300 in a forwardly within the cargo area 106 (i.e., generally adjacent to the trim panel 200), which facilitates the routing of wiring and other such electrical connections to and from the battery assembly 300.

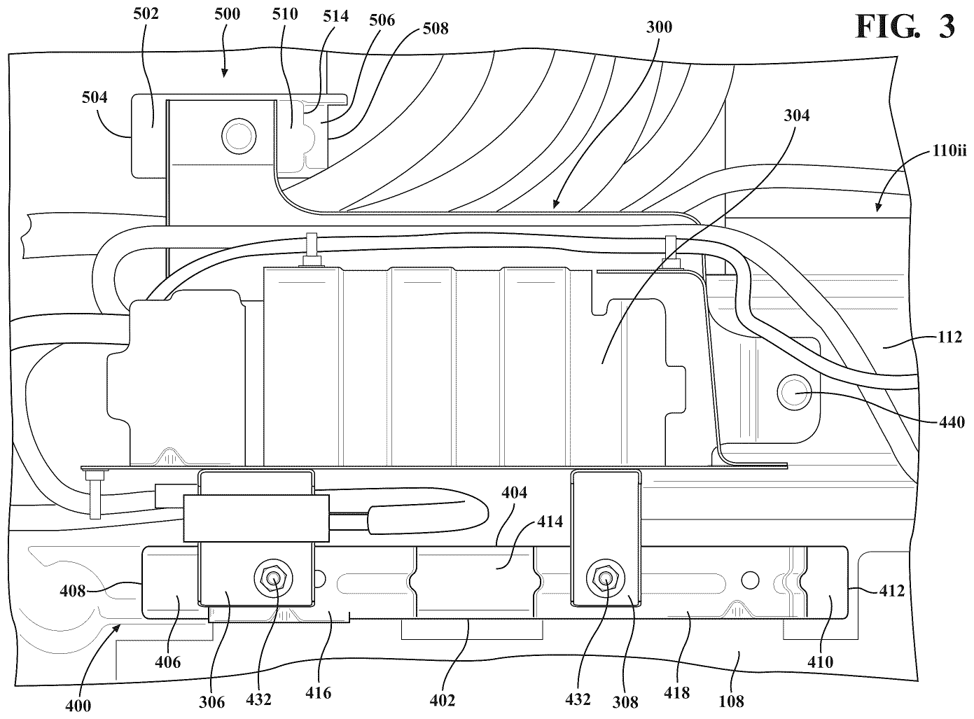

With reference now to FIGS. 3-7 as well, the mounting brackets 400, 500, 600 will be discussed. As described in further detail below, the mounting brackets 400, 500, 600 are non-identical in configuration and connect both the battery assembly 300 and the trim panel 200 to the chassis 100 (i.e., the floor panel 108) in order to increase the stability thereof.

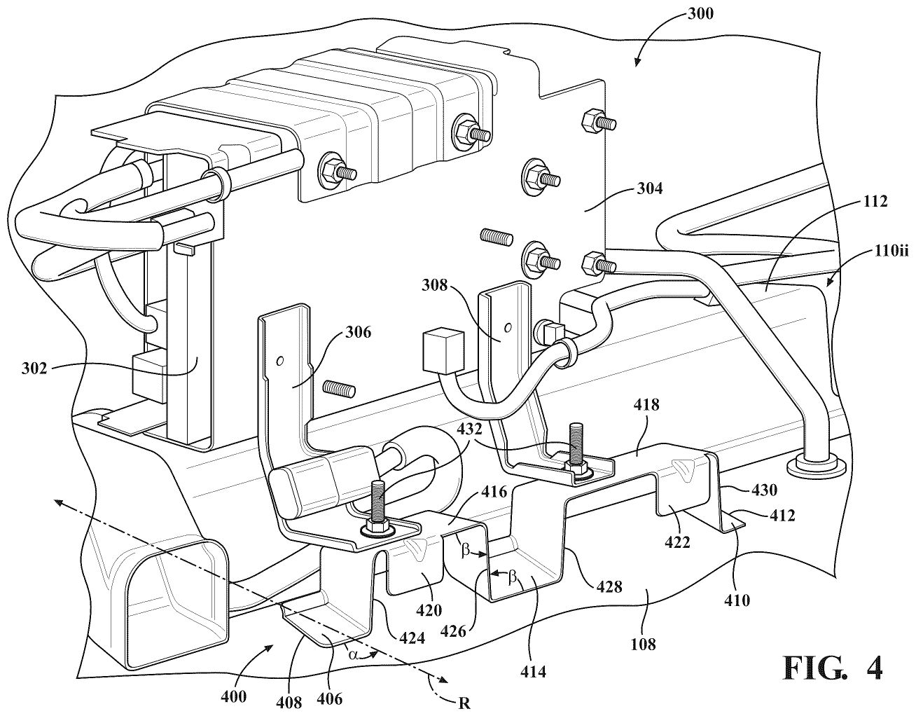

The mounting bracket 400 (FIGS. 3, 4) includes respective forward and rear ends 402, 404 and is positioned (located) forwardly of the cross-member 110ii such that the mounting bracket 400 is positioned (located) between the cross-member 110ii and the trim panel 200, as seen in FIG. 2. As described in further detail below, the mounting bracket 400 is connected (secured) to the floor panel 108, the battery assembly 300, and the trim panel 200.

The mounting bracket 400 is generally M-shaped in configuration and includes: a (first) foot 406, which is positioned (located) at (or adjacent to) a first end 408 of the mounting bracket 400; a (second) foot 410, which is positioned (located) at (or adjacent to) a second end 412 of the mounting bracket 400; a (third) foot 414, which is positioned (located) between the feet 406, 410; a (first) support 416, which is spaced vertically from the feet 406, 414 and is positioned therebetween; a (second) support 418, which is spaced vertically from the feet 410, 414 and is positioned therebetween; a (first) flange 420, which extends downwardly from the support 416; a (second) flange 422, which extends downwardly from the support 418; a (first) leg 424, which extends between the foot 406 and the support 416; a (second) leg 426, which extends between the foot 414 and the support 416; a (third) leg 428, which extends between the foot 414 and the support 418; and a (fourth) leg 430, which extends between the foot 410 and the support 418.

The feet 406, 410, 414 are directly connected (secured) (e.g., welded) to the floor panel 108. It is envisioned, however, that the mounting bracket 400 (i.e., the feet 406, 410, 414) may be connected (secured) to the floor panel 108 in any suitable manner (e.g., via one or more fasteners).

While the mounting bracket 400 is shown as including three feet 406, 410, 414, embodiments in which the particular number of feet 406, 410, 414 may be decreased or increased are also envisioned herein (e.g., depending upon the particular configuration of the battery assembly 300, the cross-member 110ii, etc.) and would not be beyond the scope of the present disclosure.

In the illustrated embodiment, at the point of connection therebetween, the floor panel 108 and the feet 406, 410, 414 extend in non-parallel relation to the reference axis R. More specifically, in the illustrated embodiment, the mounting bracket 400 is configured such that the feet 406, 410, 414 extend at generally identical acute angles α in relation to the reference axis R, which is dictated by the configuration of the floor panel 108 at the points of connection to mounting bracket 400. Embodiments in which the mounting bracket 400 may be configured such that one or more of the feet 406, 410, 414 extends in generally parallel relation to the reference axis R are also envisioned herein (e.g., depending upon the particular configuration of the floor panel 108), however, and would not be beyond the scope of the present disclosure.

The supports 416, 418 are positioned vertically below the top surface 112 of the cross-member 110ii and extend in generally parallel relation thereto. The supports 416, 418 receive (first) fasteners 432, which extend through battery brackets 306, 308, thereby directly connecting the battery brackets 306, 308 to the mounting bracket 400.

As seen in FIGS. 3 and 4, upon assembly, the battery brackets 306, 308 extend between and connect the battery case 304 and the mounting bracket 400, whereby the battery assembly 300 (i.e., the battery case 304) is indirectly connected to both the mounting bracket 400 and the floor panel 108. Connection of the battery assembly 300 to the mounting bracket 400 and the floor panel 108 stabilizes, supports, and secures the battery assembly 300 within the cargo area 106, which facilitates direct positioning (location, placement) of the battery assembly 300 atop the cross-member 110ii and inhibits (if not entirely prevents) unintended movement thereof.

While the mounting bracket 400 is shown as including two supports 416, 418 and the battery assembly 300 is shown as including two battery brackets 306, 308, embodiments in which the particular number of supports 416, 418 and battery brackets 306, 308 may be decreased or increased are also envisioned herein (e.g., depending upon the particular configuration of the battery assembly 300, the cross-member 110ii, etc.) and would not be beyond the scope of the present disclosure.

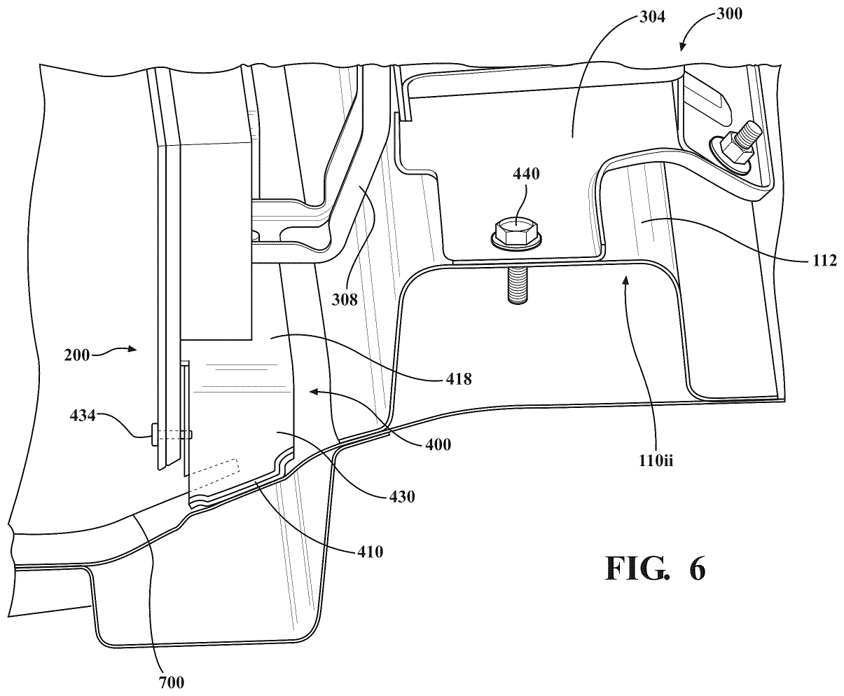

The flanges 420, 422 extend vertically from the supports 416, 418, respectively, in generally parallel relation to the trim panel 200 (FIG. 2). The flanges 420, 422 receive (second) fasteners 434 (FIGS. 2, 6), which extend through the trim panel 200 and the flanges 420, 422, thereby directly connecting the trim panel 200 to the mounting bracket 400.

In the illustrated embodiment, the mounting bracket 400 is configured such that the flanges 420, 422 extend in generally orthogonal (perpendicular) relation to the supports 416, 418. Embodiments in which the mounting bracket 400 may be configured such that the flanges 420, 422 extend in non-orthogonal (non-perpendicular) relation to the supports 416, 418 are also envisioned herein (e.g., depending upon the particular configuration and/or the orientation of the trim panel 200), however, and would not be beyond the scope of the present disclosure.

The legs 424, 426, 428, 430 elevate the supports 416, 418 (i.e., in relation to the floor panel 108) and connect the feet 406, 410, 414 thereto. Elevating the supports 416, 418 reduces the overall dimensions of the battery brackets 306, 308, which further increases the stability of the battery assembly 300.

In the illustrated embodiment, the legs 424, 426, 428, 430 extend between the feet 406, 410, 414 and the supports 416, 418 in non-orthogonal (non-perpendicular) relation thereto. More specifically, the mounting bracket 400 is configured such that the legs 424, 426, 428, 430 extend from the feet 406, 410, 414 and the supports 416, 418 at generally identical obtuse angles β. Embodiments in which the mounting bracket 400 may be configured such that one or more of the legs 424, 426, 428, 430 extends in generally orthogonal (perpendicular) relation the feet 406, 410, 414 and/or the supports 416, 418 are also envisioned herein (e.g., depending upon the particular configuration of the floor panel 108, the battery case 304, the battery brackets 306, 308, etc.), however, and would not be beyond the scope of the present disclosure.

As seen in FIG. 6, upon installation and connection of the mounting bracket 400, the carpeting 700 extends beneath the supports 416, 418 and covers the feet 406, 410, 414.

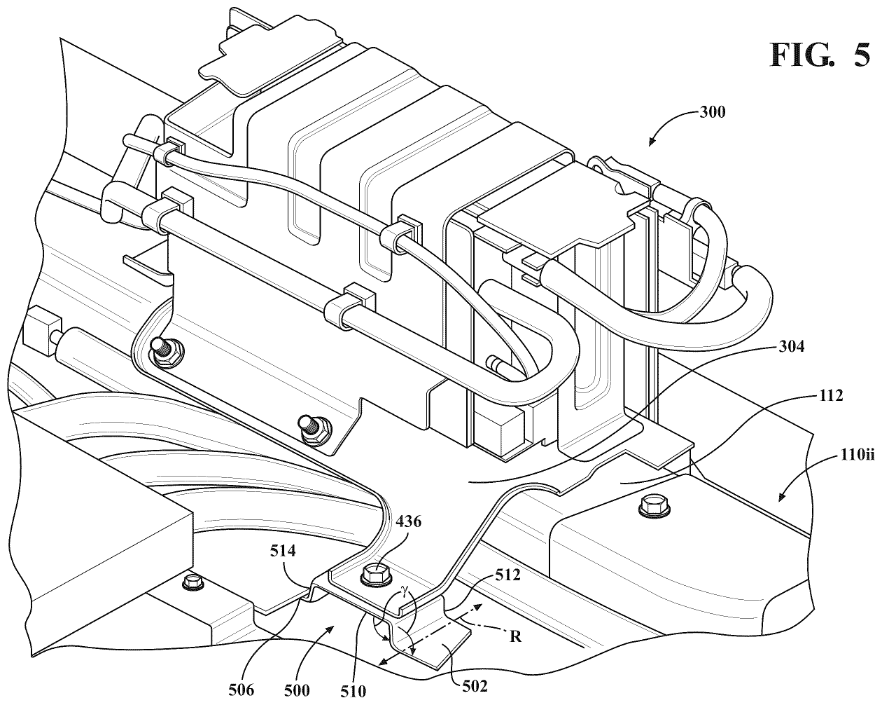

The mounting bracket 500 (FIGS. 3, 5) is connected (secured) to both the floor panel 108 and the battery assembly 300, as described in further detail below, and is positioned (located) rearwardly of the cross-member 110ii such that the mounting brackets 400, 500 are positioned (located) on opposite (i.e., forward and rear) sides of the cross-member 110ii. More specifically, the mounting bracket 500 is generally aligned with the foot 406 and the support 416 of the mounting bracket 400 along the width W of the vehicle 10, as seen in FIG. 3.

The mounting bracket 500 is generally U-shaped in configuration and includes: a (first) foot 502, which is positioned (located) at (or adjacent to) a first end 504 of the mounting bracket 500; a (second) foot 506, which is positioned (located) at (or adjacent to) a second end 508 of the mounting bracket 500; a support 510, which is spaced vertically from the feet 502, 506 and is positioned therebetween; and (first and second) legs 512, 514, which extend between the feet 502, 506 and the support 510.

The feet 502, 506 are directly connected (secured) (e.g., welded) to the floor panel 108. It is envisioned, however, that the mounting bracket 500 (i.e., the feet 502, 506) may be connected (secured) to the floor panel 108 in any suitable manner (e.g., via one or more fasteners).

While the mounting bracket 400 is shown as including two feet 502, 506, embodiments in which the particular number of feet 502, 506 may be decreased or increased are also envisioned herein (e.g., depending upon the particular configuration of the battery assembly 300, the cross-member 110ii, etc.) and would not be beyond the scope of the present disclosure.

In the illustrated embodiment, at the point of connection therebetween, the floor panel 108 and the feet 502, 506 extend in generally parallel relation to the reference axis R, which is dictated by the configuration of the floor panel 108. Embodiments in which the mounting bracket 500 may be configured such that the foot 502 and/or the foot 506 extend in non-parallel relation to the reference axis R are also envisioned herein (e.g., depending upon the particular configuration of the floor panel 108), however. For example, an embodiment in which the mounting bracket 500 may be configured such that the foot 502 and/or the foot 506 extends at an acute angle in relation to the reference axis R would not be beyond the scope of the present disclosure.

The support 510 is positioned vertically below the top surface 112 of the cross-member 110ii and extends in generally parallel relation thereto. The support 510 receives (third) fastener(s) 436, which extend through the battery case 304, thereby directly connecting the battery assembly 300 to the support 510 and indirectly connecting the battery assembly 300 to the floor panel 108. As discussed above in connection with the mounting bracket 400, connection of the battery assembly 300 to the mounting bracket 500 stabilizes, supports, and secures the battery assembly 300 within the cargo area 106, which facilitates direct positioning (location, placement) of the battery assembly 300 atop the cross-member 110ii and inhibits (if not entirely prevents) unintended movement thereof.

While the mounting bracket 500 is shown as including a single support 510, embodiments in which the particular number of supports 510 may be increased are also envisioned herein (e.g., depending upon the particular configuration of the battery assembly 300, the cross-member 110ii, etc.) and would not be beyond the scope of the present disclosure.

The legs 512, 514 elevate the support 510 (i.e., in relation to the floor panel 108) and connect the feet 502, 506 thereto. Elevating the support 510 reduces the overall dimensions of the battery case 304, which further increases the stability of the battery assembly 300.

In the illustrated embodiment, the legs 512, 514 extend between the feet 502, 506 and the support 510 in non-orthogonal (non-perpendicular) relation thereto. More specifically, the mounting bracket 500 is configured such that the legs 512, 514 extend from the feet 502, 506 and the support 510 at generally identical obtuse angles γ. Embodiments in which the mounting bracket 500 may be configured such that the leg 512 and/or the leg 514 extends in generally orthogonal (perpendicular) relation to the feet 502, 506 and/or the support 510 are also envisioned herein (e.g., depending upon the particular configuration of the floor panel 108, the battery case 304, etc.), however, and would not be beyond the scope of the present disclosure.

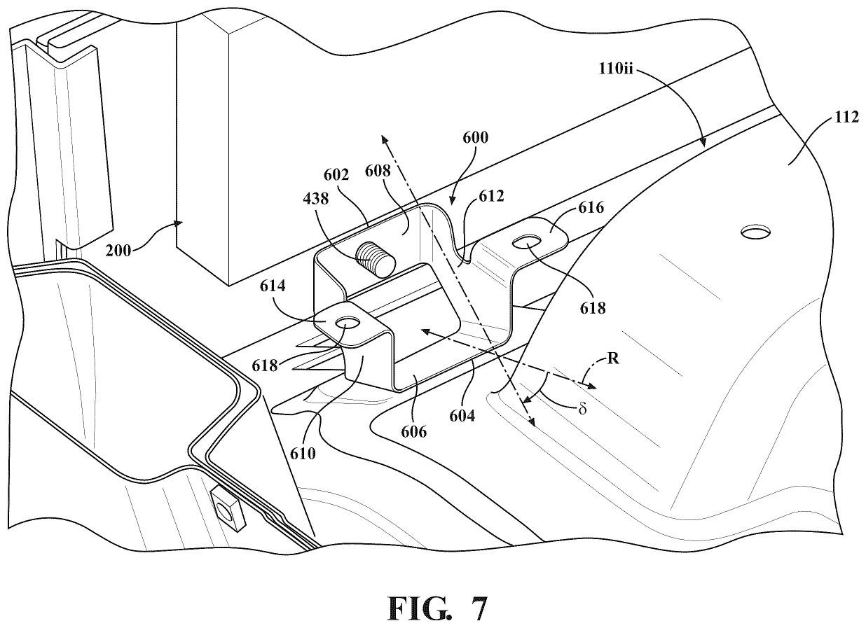

The mounting bracket 600 (FIGS. 1, 7) includes respective forward and rear ends 602, 604 and is positioned (located) forwardly of the cross-member 110ii such that the mounting bracket 600 is positioned (located) between the cross-member 110ii and the trim panel 200. More specifically, the mounting bracket 600 is positioned (located) in general alignment with the mounting bracket 400 along the width W of the vehicle 10 such that the mounting brackets 400, 600 are positioned (located) on the same (i.e., the forward) side of the cross-member 110ii, as seen in FIG. 1. As described in further detail below, the mounting bracket 600 is connected (secured) to both the floor panel 108 and the trim panel 200.

The mounting bracket 600 includes: a (first) support 606; a (second) support 608; (first and second) legs 610, 612, which extend between and connect the supports 606, 608; and (first and second) flanges 614, 616.

The support 606 is directly connected (secured) (e.g., welded) to the floor panel 108. In the illustrated embodiment, at the point of connection therebetween, the support 416 extends in generally parallel relation to the reference axis R, which is dictated by the configuration of the floor panel 108. Embodiments in which the mounting bracket 600 may be configured such that the support 606 extends in non-parallel relation to the reference axis R are also envisioned herein (e.g., depending upon the particular configuration of the floor panel 108), however. For example, an embodiment in which the mounting bracket 600 may be configured such that the support 606 extends at an acute angle in relation to the reference axis R would not be beyond the scope of the present disclosure.

The support 608 is positioned vertically above the support 606 and extends in generally orthogonal (perpendicular) relation thereto. The support 608 receives (one or more) at least one (fourth) fastener 438, which extends through the trim panel 200 and the support 608, thereby directly connecting the trim panel 200 to the mounting bracket 600.

The legs 610, 612 elevate the support 608 (i.e., in relation to the floor panel 108 and the support 606) and extend between the supports 606, 608 at generally identical acute angles δ in relation to the reference axis R. The supports 606, 608 are thus offset along the length L of the vehicle 10, with the support 608 being positioned (located) forwardly of the support 606, which increases the strength of the mounting bracket 600 and, thus, the stability of the trim panel 200.

The flanges 614, 616 extend laterally (horizontally) outward from the legs 610, 612, respectively, along the width W of the vehicle 10 and include openings 618. The openings 618 provide alignment features that are utilized during installation of the mounting bracket 600 (i.e., welding of the support 606 to the floor panel 108).

In certain embodiments, it is envisioned that the battery assembly 300 (i.e., the battery case 304) may be directly connected to the cross-member 110ii via a fastener 440, as seen in FIGS. 1, 3, and 6. Directly connecting the battery assembly 300 to the cross-member 110ii further stabilizes, supports, and secures the battery assembly 300 within the cargo area 106, which further facilitates direct positioning (location, placement) of the battery assembly 300 atop the cross-member 110ii and further inhibits (if not entirely prevents) unintended movement of the battery assembly 300.

While the battery assembly 300 is shown as being connected to the cross-member 110ii by a single fastener 440, embodiments in which the particular number of fasteners 440 may be increased are also envisioned herein (e.g., depending upon the particular configurations of the battery assembly 300 and the cross-member 110ii, the locations of the mounting brackets 400, 500, etc.), however, as are embodiments that are devoid of the fastener 440, and would not be beyond the scope of the present disclosure.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of. ” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (i.e., an angle that lies within the range of (approximately) 135° to (approximately) 225°) and the term “generally orthogonal” should be understood as referring to configurations in with the pertinent components are oriented so as to define an angle therebetween that is equal to 90°±25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a chassis defining:
a passenger seating area; and
a cargo area located rearwardly of the passenger seating area, wherein the chassis includes:
a floor panel; and
a cross-member extending upwardly from the floor panel;
a trim panel separating the passenger seating area from the cargo area;
a first mounting bracket connected to the floor panel forwardly of the cross-member;
a second mounting bracket connected to the floor panel rearwardly of the cross-member;
a third mounting bracket connected to the floor panel forwardly of the cross-member, wherein the first mounting bracket and the third mounting bracket are connected to the trim panel to increase stability thereof; and
a battery assembly supported by the cross-member, wherein the battery assembly includes:
a battery; and
a battery case receiving the battery, wherein the first mounting bracket and the second mounting bracket are connected to the battery case to thereby secure the battery assembly within the cargo area.

2. The vehicle of claim 1, wherein the battery case is indirectly connected to the first mounting bracket.

3. The vehicle of claim 2, wherein the battery assembly further includes:
battery brackets extending between and connecting the battery case and the first mounting bracket.

4. The vehicle of claim 1,wherein the battery case is directly connected to the second mounting bracket.

5. The vehicle of claim 1, wherein the battery case is directly connected to the cross-member.

6. A vehicle comprising:
a chassis defining:
a passenger seating area; and
a cargo area located rearwardly of the passenger seating area, wherein the chassis includes:
a floor panel; and
a cross-member extending upwardly from the floor panel;
a battery assembly supported by the cross-member;
a first mounting bracket connected to the floor panel forwardly of the cross-member; and
a second mounting bracket connected to the floor panel rearwardly of the cross-member, wherein the first mounting bracket and the second mounting bracket are connected to the battery assembly to thereby secure the battery assembly within the cargo area.

7. The vehicle of claim 6, wherein the first mounting bracket includes:
a first foot positioned at a first end of the first mounting bracket;
a second foot positioned at a second end of the first mounting bracket; and
a third foot positioned between the first foot and the second foot, wherein the first foot, the second foot, and the third foot are directly connected to the floor panel.

8. The vehicle of claim 7, wherein the first foot, the second foot, and the third foot extend at an acute angle in relation to a reference axis extending in parallel relation to a length of the vehicle.

9. The vehicle of claim 8, wherein the first mounting bracket further includes:
a first support spaced vertically from the first foot and the third foot and positioned therebetween; and
a second support spaced vertically from the second foot and the third foot and positioned therebetween such that the first mounting bracket is generally M-shaped in configuration.

10. The vehicle of claim 9, wherein the battery assembly is indirectly connected to the first mounting bracket.

11. The vehicle of claim 10, wherein the battery assembly includes:
a battery;
a battery case receiving the battery; and
battery brackets extending between and connecting the battery case and the first mounting bracket.

12. The vehicle of claim 11, wherein the battery brackets are connected to the first support and the second support.

13. The vehicle of claim 9, further comprising:
a trim panel separating the passenger seating area from the cargo area, wherein the trim panel is connected to the first mounting bracket to increase stability thereof.

14. The vehicle of claim 13, wherein the first mounting bracket further includes:
a first flange extending downwardly from the first support; and
a second flange extending downwardly from the second support, wherein the first flange and the second flange receive first fasteners connecting the trim panel to the first mounting bracket.

15. The vehicle of claim 14, further comprising:
a third mounting bracket connected to the floor panel forwardly of the cross-member, wherein the third mounting bracket receives at least one second fastener connecting the trim panel to the third mounting bracket to increase stability thereof.

16. A vehicle comprising:
a chassis defining:
a passenger seating area; and
a cargo area located rearwardly of the passenger seating area, wherein the chassis includes:
a floor panel; and
a cross-member extending upwardly from the floor panel;
a trim panel separating the passenger seating area from the cargo area;
a battery assembly supported by the cross-member; and
a first mounting bracket and a second mounting bracket connected to the floor panel, wherein the battery assembly is connected to the first mounting bracket to thereby secure the battery assembly within the cargo area, and the trim panel is connected to the first mounting bracket and the second mounting bracket to increase stability of the trim panel.

17. The vehicle of claim 16, wherein the first mounting bracket and the second mounting bracket are non-identical in configuration.

18. The vehicle of claim 16, wherein the first mounting bracket and the second mounting bracket are positioned forwardly of the cross-member.

19. The vehicle of claim 18, wherein the first mounting bracket and the second mounting bracket are generally aligned along a width of the vehicle.

20. The vehicle of claim 16, wherein the vehicle further includes:
a storage box positioned within the cargo area;
a platform extending between the storage box and the trim panel; and
carpeting positioned within the cargo area, wherein the carpeting extends beneath the first mounting bracket.
